(19) United States
(12) Patent Application Publication
(10) Pub. No.: US 2014/0110399 A1
(43) Pub. Date: Apr. 24, 2014

(54) WIRE CONNECTION STRUCTURE FOR THREE-PHASE SHEATH TYPE HEATER, THREE-PHASE SHEATH TYPE HEATER PROVIDED WITH THE STRUCTURE, AND WIRE CONNECTION METHOD FOR THREE-PHASE SHEATH TYPE HEATER

(71) Applicants: Kensuke NORITAKE, Osaka (JP); Norio NISHIBE, Osaka (JP)

(72) Inventors: Kensuke NORITAKE, Osaka (JP); Norio NISHIBE, Osaka (JP)

(21) Appl. No.: 13/918,076

(22) Filed: Jun. 14, 2013

Related U.S. Application Data
(60) Provisional application No. 61/715,474, filed on Oct. 18, 2012.

(51) Int. Cl. H01R 4/02; H01R 43/02; H01R 43/00; H05B 3/06

(52) U.S. Cl. CPC H01R 4/029; H05B 3/06; H01R 43/0263; H01R 43/005
USPC 219/541; 29/879; 29/883; 174/74 R

(57) ABSTRACT

Provided is a wire connection structure for a three-phase sheath type heater that enables to maintain insulation properties, electrical safety, and reliability, without damaging a wire connection portion, even if an installation location is a high-temperature, high-pressure environment, and enables to flow a large electric current, while suppressing the production cost. A canister 2 made of metal is disposed on the distal end side of three sheath type heating elements 10 in a state that a distal end of each of the sheath type heating elements 10 is inserted through a bottom plate 20. A wire connection plate 3 made of metal is disposed in the canister 2 for star-connection. Distal ends of core wires 11 of the sheath type heating elements 10 are joined to the wire connection plate 3 by welding. An insulating material 4 is compressively filled in the remaining space of the canister.

### TECHNICAL FIELD

The present invention relates to a wire connection structure for a sheath type heater of three-phase load type for heating fluid or solid material in various conditions such as the inside of a pipe, in the ground, or in a vacuum device, and more particularly to an impact or vibration resistant wire connection structure for a three-phase sheath type heater that enables to maintain electrical safety and reliability, and that can be appropriately used in a high-temperature, high-pressure environment.

### BACKGROUND ART

Conventionally, a three-phase sheath type heater is configured in such a manner that a box is disposed on a distal end side of three sheath type heating elements, and core wires, each of which is exposed from an end of each of the sheath type heating elements, are connected to each other in the box with use of a terminal block or a crimp terminal fastened by a bolt. In such a wire connection, if a large electric current flows, the wire connection portion is heated to a high temperature, and may be damaged. Thus, possibility of electric danger is increased. Further, particularly, in the case where the sheath type heater is used in a high-temperature, high-pressure environment, vibration or impact may be exerted on the box directly or indirectly via a heater sheath. In such a condition, a bolt for fixing the core wires may be loosened by the vibration or impact at the wire connection portion of the terminal block or the crimp terminal fastened by a bolt. Further, it is highly likely that a joint portion between the heater sheath and the box is damaged by an external force such as tension, compression, twisting, or impact applied from the heater sheath. As a result, a large force may be directly exerted on the core wires or the wire connection portion. This may result in loosing of the bolt or damage of the wire connection portion, and may increase the possibility of electric danger such as lowering of electrical connection or wire disconnection. Further, moisture or the like may be intruded into the box or the heater sheath by way of the damaged joint portion. This may seriously lower the insulation properties, and it is difficult to maintain safety and reliability.

Further, there is proposed a structure, in which three core wires are housed in one heater sheath, and distal ends of the core wires are connected to each other within the heater sheath, as shown in a cartridge type heater (e.g. see Patent Document 1). In the above configuration, three core wires are housed and connected to each other in one heater sheath, unlike a configuration, in which core wires exposing from a distal end side of three sheath type heating elements are connected to each other. Accordingly, in the above configuration, high precision in assembling the parts is required, the degree of freedom in processing is lowered, and the production cost may be increased. Further, it is impossible to flow a large electric current in order to secure insulation properties between the core wires within the heater sheath. This limits the environment in which the heater can be used. Further, there is a limit in securing strength against vibration of the wire connection portion, and in improving safety and reliability on electrical connection.

### CITATION LIST

### Patent Literatures

Patent Document 1: JP-B No. H02-34158

### SUMMARY OF INVENTION

### Technical Problem

In view of the above, an object of the invention is to provide a wire connection structure for a three-phase sheath type heater, a three-phase sheath type heater provided with the structure, and a wire connection method for a three-phase sheath type heater that enable to maintain insulation properties, electrical safety, and reliability, without damaging a wire connection portion, even if an installation location is a high-temperature, high-pressure environment, and enable to flow a large electric current, while suppressing the production cost.

### Solution to Problem

In order to solve the above drawbacks, an aspect of the invention is directed to a wire connection structure for a three-phase sheath type heater characterized in that a canister made of metal is disposed on a distal end side of three sheath type heating elements in a state that a distal end of each of the sheath type heating elements is inserted through a bottom plate, distal ends of core wires of the sheath type heating elements are star-connected to each other directly or indirectly via another member by welding in the canister, and an insulating material is filled in the canister.

In the above wire connection structure, preferably, each of the sheath type heating elements may be fixed to a peripheral portion of a through-hole in the bottom plate directly or indirectly via another member attached to an outer circumferential portion of a sheath by welding from an inner side of the canister.

In particular, in the above wire connection structure, preferably, a hexagonal caulk bushing may be attached to the distal end of each of the three sheath type heating elements, and each of the hexagonal caulk bushings, as the another member, to be inserted into the canister together with the sheath type heating element may be fixed to the peripheral portion of the through-hole by welding.

Further, the above wire connection structure may preferably further include one or more reinforcing plates, wherein the reinforcing plate has three through-holes formed therein to allow passing of the hexagonal caulk bushings extending to an outside of the canister, respectively, and each of the hexagonal caulk bushings passing through the corresponding through-hole is fixed to the peripheral portion of the through-hole by welding from an upper surface side of the reinforcing plate.

Further, in the above wire connection structure, preferably, the canister may be constituted of the bottom plate, a tubular side wall which surrounds the distal ends of the three sheath type heating elements passing through the bottom plate, and a top plate which covers an upper end opening of the side wall in a state that the top plate is inserted in the opening, and the insulating material inside the canister may be compressively filled by inserting the top plate into the opening.

In particular, in the above wire connection structure, preferably, the top plate may be fixed to the side wall by fillet-welding at a step portion with respect to an upper end surface of the side wall.

Further, the above wire connection structure may preferably further include an insulating member which is disposed at a root portion of the core wire of each of the sheath type heating elements for preventing discharge accident between the core wire and a sheath.

In particular, in the above wire connection structure, preferably, the insulating member may be an insulator made of alumina matter.

Further, in the above wire connection structure, preferably, the another member for indirectly star-connecting the distal ends of the core wires of the sheath type heating elements to each other by welding may be a wire connection plate made of metal, the wire connection plate being configured such that the distal ends of the core wires of the sheath type heating elements are connected to the wire connection plate by welding for star-connecting the three sheath type heating elements in the canister.

In particular, in the above wire connection structure, preferably, the wire connection plate may have three seat portions equidistantly formed therein for receiving the distal ends of the core wires of the sheath type heating elements, the seat portion being a hole or a groove.

Further, the above wire connection structure may preferably further include a sleeve pipe which is fixedly attached to the distal end of each of the core wires by caulking, the sleeve pipe being made of copper or copper alloy, wherein the sleeve pipe is fixed to the seat portion by welding.

Further, in the above wire connection structure, preferably, the wire connection plate may have a passage hole formed in a center portion thereof to allow passing of the insulating material in an axis direction when the insulating material is compressively filled.

Further, the above wire connection structure may preferably further include a tubular insulation pipe which is disposed between an outer circumferential surface of the wire connection plate, and an inner circumferential surface of the canister, wherein the tubular insulation pipe extends to an upper surface of the bottom plate of the canister.

Further, in the above wire connection structure, preferably, the core wires may be directly star-connected to each other by welding in a state that the distal ends of the core wires of the sheath type heating elements are bundled together by a bundling member in the canister.

In particular, the above wire connection structure may preferably further include a sleeve pipe which is fixedly attached to the distal end of each of the core wires by caulking, the sleeve pipe being made of copper or copper alloy, wherein the core wires with the sleeve pipes are directly star-connected to each other by welding in a state that the core wires are bundled together by the bundling member.

Further, the invention also provides a three-phase sheath type heater provided with the wire connection structure of any one of the above configurations.

Furthermore, the invention also provides a wire connection method for a three-phase sheath type heater including a step of inserting a distal end of each of three sheath type heating elements through a bottom plate of a canister made of metal; a step of star-connecting distal ends of core wires of the sheath type heating elements to each other directly or indirectly via another member by welding; and a step of filling an insulating material into the canister.

The above wire connection method may preferably further include a step of fixing each of the sheath type heating elements to a peripheral portion of a through-hole in the bottom plate directly or indirectly via another member attached to an outer circumferential portion of a sheath by welding from an inner side of the canister.

In particular, the above wire connection method may preferably further include a step of attaching a hexagonal caulk bushing to the distal end of each of the three sheath type heating elements, wherein each of the hexagonal caulk bushings, as the another member, to be inserted into the canister together with the sheath type heating element is fixed to the peripheral portion of the through-hole by welding.

Further, the above wire connection method may preferably further include a step of passing the hexagonal caulk bushings through three through-holes formed in one or more reinforcing plates to allow passing of the hexagonal caulk bushings extending to an outside of the canister, respectively, and of fixing each of the hexagonal caulk bushings to the peripheral portion of the corresponding through-hole by welding from an upper surface side of the reinforcing plate.

Further, in the above wire connection method, preferably, the canister may be constituted of the bottom plate, a tubular side wall which surrounds the distal ends of the three sheath type heating elements passing through the bottom plate, and a top plate which covers an upper end opening of the side wall in a state that the top plate is inserted in the opening, and the method may further include a step of compressively filling the insulating material inside the canister by inserting the top plate into the opening.

In particular, the above wire connection method may preferably further include a step of fixing the top plate to the side wall by fillet-welding at a step portion with respect to an upper end surface of the side wall.

Further, the above wire connection method may preferably further include a step of disposing an insulating member at a root portion of the core wire of each of the sheath type heating elements for preventing discharge accident between the core wire and a sheath.

Further, in the above wire connection method, preferably, the another member for indirectly star-connecting the distal ends of the core wires of the sheath type heating elements to each other by welding may be a wire connection plate made of metal in the canister, and the distal ends of the core wires of the sheath type heating elements may be star-connected to the wire connection plate by welding.

In particular, in the wire connection method, preferably, the wire connection plate may have three seat portions equidistantly formed therein for receiving the distal ends of the core wires of the sheath type heating elements, the seat portion being a hole or a groove, the method may further include a step of fixedly attaching a sleeve pipe to the distal end of each of the core wires by caulking, the sleeve pipe being made of copper or copper alloy, and the sleeve pipe may be fixed to the seat portion of the wire connection plate by welding.

Further, in the above wire connection method, preferably, the wire connection plate may have a passage hole formed in a center portion thereof to allow passing of the insulating material in an axis direction when the insulating material is compressively filled, and the insulating material fed inside the canister may be compressively filled by inserting the top plate into the opening to thereby compressively fill the insulating material fed to a distal end side of the wire connection plate, and at the same time, to migrate the compressed insulating material toward a base end side of the wire connection plate through the passage hole for compressively filling the insulating material fed to the base end side.

In particular, the above wire connection method may preferably further include a step of disposing a tubular insulation pipe between an outer circumferential surface of the wire connection plate, and an inner circumferential surface of the canister, wherein the tubular insulation pipe extends to an upper surface of the bottom plate of the canister.

Further, in the above wire connection method, preferably, the core wires may be directly star-connected to each other by welding in a state that the distal ends of the core wires of the sheath type heating elements are bundled together by a bundling member in the canister.

In particular, the above wire connection method may preferably further include a step of fixedly attaching a sleeve pipe to the distal end of each of the core wires by caulking, the sleeve pipe being made of copper or copper alloy, wherein the core wires with the sleeve pipes are directly star-connected to each other by welding in a state that the core wires are bundled together by the bundling member.

### Advantageous Effects of Invention

In the wire connection structure for a three-phase sheath type heater, the three-phase sheath type heater provided with the structure, and the wire connection method for a three-phase sheath type heater of the invention as described above, the core wires are firmly fixed by welding and protected in the metal canister. Accordingly, mechanical strength and electrical connection of the wire connection portion of the core wires are significantly enhanced. Thus, even if an external force such as tension, compression, twisting, or impact is exerted on the canister directly or indirectly via a heater sheath in a high-temperature, high-pressure environment, it is possible to maintain safety and reliability, without damaging the wire connection portion or lowering electrical connection.

Further, the structure is configured such that a stress is less likely to act on the wire connection portion thanks to the existence of the canister and the insulating material. This ensures insulation properties of the wire connection portion of the core wires with respect to the canister or the heater sheath, significantly enhances electrical safety, and makes it possible to implement a high reliable structure. Further, the above configuration makes it easy to assemble the parts, and makes it possible to suppress the production cost, as compared with a configuration, in which three core wires are connected to each other in a heater sheath. Further, in the case where a wire connection plate is used, by appropriately setting the thickness of the wire connection plate, it is possible to configure an electrically safe wire connection structure while suppressing heat generation, even if a large electric current flows.

Further, each of the sheath type heating elements is fixed to the peripheral portion of the through-hole in the bottom plate directly or indirectly via another member attached to the outer circumferential portion of the sheath by welding from the inner side of the canister. This makes it possible to securely and firmly integrate each of the heater sheaths with the canister. Accordingly, even if an external force such as tension, compression, twisting, or impact is exerted on the heater sheaths, there is no relative movement between the heater sheaths or between the core wires within the canister. Thus, it is possible to prevent damage of the wire connection portion in advance, even if a stress acts on the wire connection portion. This enhances electrical connection and safety. Further, sealability of the welded joint portion between the heater sheaths and the canister is maintained. Accordingly, it is possible to prevent intrusion of moisture into the canister. Thus, it is possible to provide a wire connection structure with enhanced safety and reliability, while maintaining insulation properties.

Further, a hexagonal caulk bushing is attached to the distal end of each of the three sheath type heating elements, and each of the hexagonal caulk bushings, as the another member, to be inserted into the canister together with the sheath type heating element is fixed to the peripheral portion of the through-hole by welding. This reinforces the heater sheaths, without causing flexure or the like, and makes it possible to prevent application of an external force to the joint portion with respect to the canister. Further, it is possible to firmly integrate the heater sheaths with the canister via the hexagonal caulk bushings. Particularly, it is possible to prevent twisting (turning) of the heater sheaths by the provision of the hexagonal caulk bushings. Thus, it is possible to securely prevent a stress from acting on the wire connection portion in the canister. Further, it is possible to weld thickly, as compared with a configuration, in which a heater sheath is directly welded to a canister bottom plate. This makes it possible to increase the joint strength.

Further, there is provided one or more reinforcing plates. The reinforcing plate has three through-holes formed therein to allow passing of the hexagonal caulk bushings extending to an outside of the canister, respectively, and each of the hexagonal caulk bushings passing through the corresponding through-hole is fixed to the peripheral portion of the through-hole by welding from an upper surface side of the reinforcing plate. This makes it possible to integrate the heater sheaths, each of which is reinforced, with each other via the reinforcing plate, and makes it possible to firmly reinforce the heater sheaths with each other without causing flexure, twisting, or the like. Further, it is possible to prevent twisting between the heater sheaths, and it is possible to firmly integrate the three sheath type heating elements with the canister. Thus, it is possible to securely prevent application of an external force on the joint portion with respect to the canister and the wire connection portion in the canister.

Further, the wire connection plate has three seat portions equidistantly formed therein for receiving the distal ends of the core wires of the sheath type heating elements, and the seat portion is a hole or a groove. Accordingly, it is possible to increase the strength of the welded portion between the wire connection plate and the core wires, and to perform positioning between the core wires before welding. This enhances the workability.

Further, a sleeve pipe made of copper or copper alloy is fixedly attached to the distal end of each of the core wires by caulking, and the sleeve pipe is fixed to the seat portion by welding. Accordingly, it is possible to enhance joint strength with respect to the wire connection plate by welding, and to enhance electrical connection while increasing the strength.

Further, the canister is constituted of the bottom plate, a tubular side wall which surrounds the distal ends of the three sheath type heating elements passing through the bottom plate, and a top plate which covers an upper end opening of the side wall in a state that the top plate is inserted in the opening. Further, the insulating material inside the canister is compressively filled by inserting the top plate into the opening. The above configuration makes it easy to weld the sheath type heating elements to the bottom plate directly or indirectly via another member. Further, it is possible to assemble the structure by mounting the side wall after the wire connecting operation of the core wires is performed, filling the insulating material in the remaining space (clearance) in the canister, and mounting the top plate. Thus, the above configuration makes it easy to weld the wire connection portion in a state the side wall is not mounted. This significantly enhances the workability. Further, the top plate serves as a cover, which is mounted in a state that the top plate is inserted in the upper end opening of the side wall. Accordingly, it is possible to increase the distance by which the top plate is inserted by increasing the thickness of the top plate. This makes it easy to increase the filling rate of the insulating material in the canister.

Further, the top plate is fixed to the side wall by fillet-welding at a step portion with respect to an upper end surface of the side wall. This makes it possible to firmly joint by welding, and makes it possible to enhance mechanical strength and sealability.

Further, in the case where a wire connection plate is used, the wire connection plate has a passage hole formed in a center portion thereof to allow passing of the insulating material in an axis direction when the insulating material is compressively filled. Accordingly, in compressing the insulating material filled in the canister by insertion of the top plate, a compression force is also exerted on the insulating material filled on the bottom plate side of the wire connection plate through the passage hole. This makes it possible to uniformly compress the insulating material in the canister.

Further, a tubular insulation pipe is disposed between an outer circumferential surface of the wire connection plate, and an inner circumferential surface of the canister, and the tubular insulation pipe extends to an upper surface of the bottom plate of the canister. Accordingly, even if the side wall is deformed or the wire connection portion may move by application of an external force such as impact applied to the canister, the insulation pipe disposed between the side wall and the wire connection pipe, or between the side wall and the heater sheaths prevents contact discharge. Thus, it is possible to maintain insulation properties, thereby maintaining electrical safety.

Further, an insulating member is disposed at a root portion of the core wire of each of the sheath type heating elements for preventing discharge accident between the core wire and a sheath. This makes it possible to enhance electrical safety.

Further, the core wires are directly star-connected to each other by welding in a state that the distal ends of the core wires of the sheath type heating elements are bundled together by a bundling member in the canister. Accordingly, it is possible to firmly fix the core wires to each other by welding with a simplified structure, without using the wire connection plate.

### BRIEF DESCRIPTION OF THE DRAWINGS

FIG. 1 is a perspective view showing a wire connection structure for a three-phase sheath type heater, as a representative embodiment of the invention.

FIG. 2 is a side view of the structure.

FIG. 3 is an exploded perspective view of the structure.

FIG. 4 is a partially cutaway perspective view of the structure.

FIG. 5 is a longitudinal sectional view showing essential parts of the structure.

FIG. 6 is a longitudinal sectional view showing a modification.

FIG. 7 is a side view of the modification, with some parts thereof being omitted.

FIG. 8 is a flowchart showing a sequence of assembling the wire connection structure as the representative embodiment of the invention.

FIG. 9 is a partially cutaway perspective view showing essential parts of another modification.

FIG. 10 is a longitudinal sectional view of the modification.

### DESCRIPTION OF EMBODIMENTS

In the following, an embodiment of the invention is described referring to the accompanying drawings in detail.

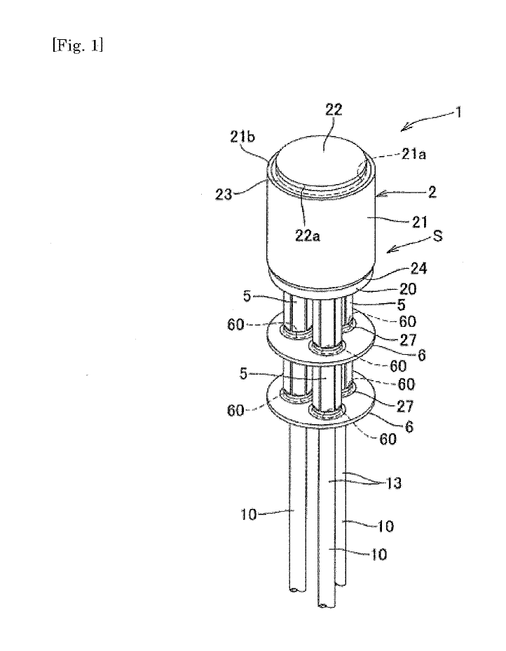

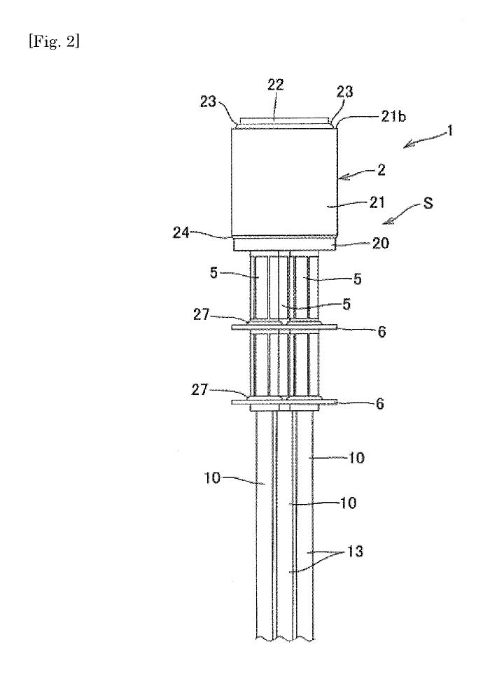

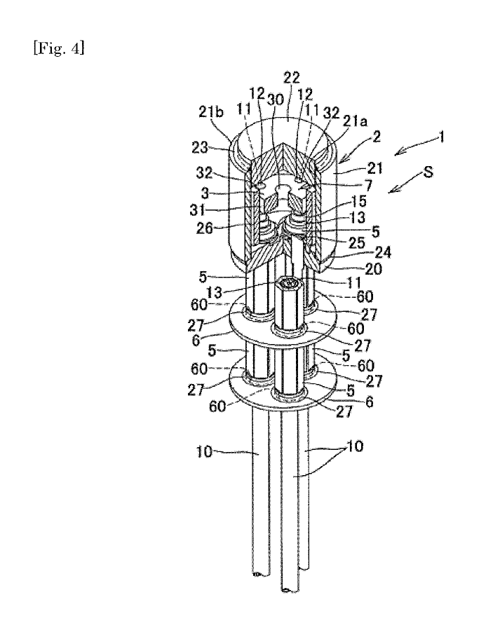

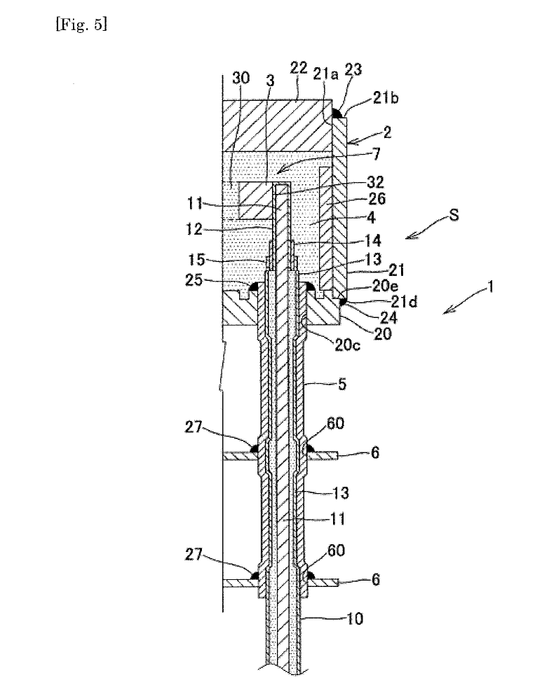

As shown in FIGS. 1 to 5, a wire connection structure S for a three-phase sheath type heater 1 of the invention is constructed as follows. Specifically, a canister 2 made of metal is disposed on the distal end side of three sheath type heating elements 10, 10, and 10 in a state that a distal end of each of the sheath type heating elements 10 is inserted through a bottom plate 20. A wire connection plate 3 made of metal for star connection is disposed in the canister 2 in a state that a distal end of a core wire 11 of each of the sheath type heating elements 10 is joined to the wire connection plate 3 by welding. Further, as shown in FIG. 5, an insulating material 4 is compressively filled in the remaining space of the canister 2.

The sheath type heating element 10 is a sheath type heating element such as a conventional micro heater or sheathed heating element (with one resistance line). A three-phase heater is configured by connecting (star-connecting) the distal ends of the three sheath type heating elements 10 to each other. A base end of each of the sheath type heating elements 10 is subjected to terminal treatment, and is connected to a power source cable within an unillustrated connection box. A hexagonal caulk bushing 5 is attached to an outer circumferential portion of a heater sheath of each of the sheath type heating elements 10 by a hexagonal caulk. Distal ends of the hexagonal caulk bushings 5 protrude into the canister 2, and are attached to the bottom plate 20 from the inner side of the canister 2 by welding all around (see welded portions 25).

The canister 2 is made of stainless steel. The canister 2 is constituted of the bottom plate 20 through which the three sheath type heating elements 10 pass, a tubular side wall 21 which surrounds the distal ends of the three sheath type heating elements 10 passing through the bottom plate 20, and a top plate 22 which covers an upper end opening 21a formed in the side wall 21. The top plate 22 serves as a cover which covers the upper end opening 21a of the side wall 21 in a state that the top plate 22 is inserted in the upper end opening 21a. The insulating material 4 in the canister 2 is compressively filled by inserting the top plate 22 into the upper end opening 21a.

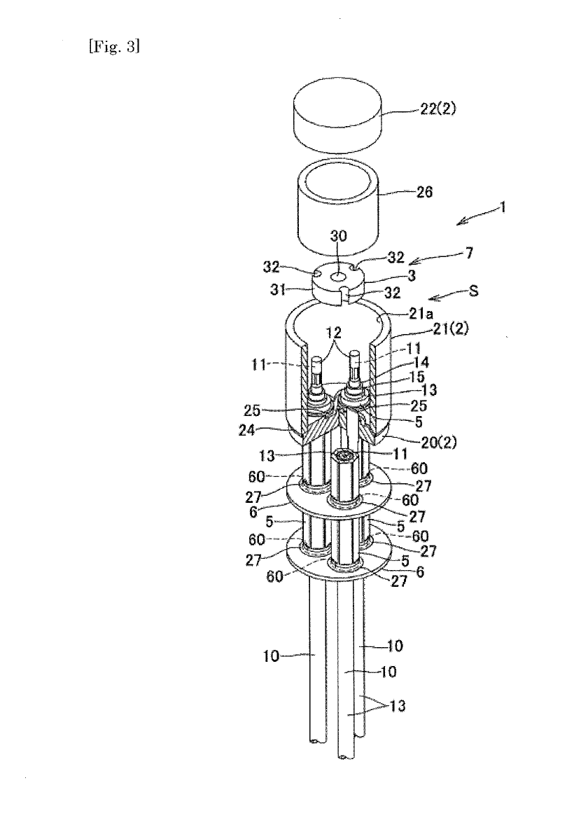

The bottom plate 20 is a member serving as a base block of the canister 2. The bottom plate 20 is a thick stainless member having three through-holes 20c formed therein for passing the sheath type heating elements 10 therethrough. Forming the bottom plate 20 into a thick plate as described above prevents deformation of a wire connection portion in the canister 2 by application of an external force such as twisting or tension to the heater sheaths. Further, as shown in FIGS. 3 to 5, an engaging groove 20e in the form of cutaway is formed in an outer periphery on an upper surface of the bottom plate 20 for partial engagement of a lower end surface 21d of the side wall 21 in the engaging groove 20e. The bottom plate 20 and the side wall 21 are joined to each other by welding all around by fillet-welding at a step portion between an outwardly protruding portion of the lower end surface 21d of the side wall 21 engaged in the engaging groove 20e, and an outer circumferential surface of the bottom plate 20 (see a welded portion 24).

As shown in FIG. 3 and FIG. 5, the distal end of each of the sheath type heating elements 10 passing through the bottom plate 20 of the canister 2 is such that core wires 11 are exposed from heater sheath end portions by a required length. A sleeve pipe 12 made of copper or copper alloy is fixedly attached to the distal end of each of the core wires 11 by caulking. Further, an insulation ring 14 and an insulator 15 made of alumina matter are disposed at a root portion of each of the core wires 11 as insulating members for preventing discharge accident between the core wires 11 and heater sheaths 13.

The wire connection plate 3 is a disc plate made of copper. Three seat portions 32, 32, and 32 in the form of concave grooves for receiving the distal ends of the core wires 11 are formed equidistantly along an outer circumferential surface 31. Further, a passage hole 30 is formed in a center portion of the wire connection plate 3 for passing the insulating material 4 in the axis direction in compressively filling the insulating material 4. Specifically, the sleeve pipes 12 mounted on the core wires 11 are fixed to the wire connection plate 3 by welding in a state that the sleeve pipes 12 are inserted and mounted in the seat portions 32. Thus, a wire connection portion 7 is formed of the core wires 11, the sleeve pipes 12, and the wire connection plate 3.

As shown in FIGS. 3 to 5, a tubular insulation pipe 26 extending to the upper surface or to the vicinity of the upper surface of the bottom plate 20 of the canister 2 is disposed between the outer circumferential surface 31 of the wire connection plate 3 constituting the wire connection portion 7, and an inner circumferential surface of the canister 2. This enhances insulation properties between the core wires 11, the wire connection plate 3 (wire connection portion 7), and the canister side wall 21, and insulation properties between the sheaths, the hexagonal caulk bushings 5, and the canister side wall 21, and enhances electrical safety. An example of the insulation pipe 26 is an insulator made of alumina matter. As the insulating material 4 to be compressively filled in the canister 2, it is possible to use a conventional insulating material filled in a sheath of a sheath type heating element, such as magnesia (MgO).

The top plate 22 serving as a cover for the canister 2 is a thick stainless member. As shown in FIG. 5, after the insulating material 4 is filled in the side wall 21, the top plate 22 is inserted and mounted in the side wall opening 21a. Then, the lower surface of the bottom plate 20 and the upper surface of the top plate 22 are clamped together by a vise or a like apparatus, while applying vibration to the entirety of the canister 2, accompanied by pressing insertion of the top plate 22 into the side wall 21 for increasing the filling rate of the insulating material 4. Then, a step portion between an upper end surface 21b of the side wall 21, and an outer circumferential surface 22a of the top plate 22 protruding upward from the upper end surface 21b are fillet-welded, whereby the side wall 21 and the top plate 22 are joined to each other by welding all around (see a welded portion 23).

Two reinforcing plates 6 are attached to the hexagonal caulk bushings 5, 5, and 5 extending downward to the outside of the canister 2 to be axially away from each other. The reinforcing plates 6 are provided for integral interconnection between the three hexagonal caulk bushings 5 while preventing relative movement thereof. In the embodiment, two reinforcing plates are provided, but one or more than two reinforcing plates may be provided. Specifically, three through-holes 60, 60, and 60 for passing the respective hexagonal caulk bushings 5, 5, and 5 are formed in each of the reinforcing plates 6. The hexagonal caulk bushing 5 passing through each of the through-holes 60 is joined to a peripheral portion of the corresponding through-hole 60 from the upper surface side (on the surface corresponding to the canister side in the axis direction) by welding all around (see welded portions 27).

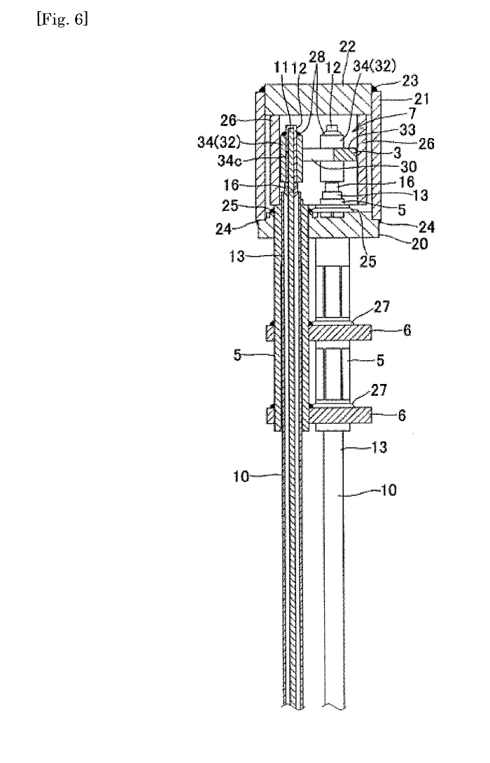

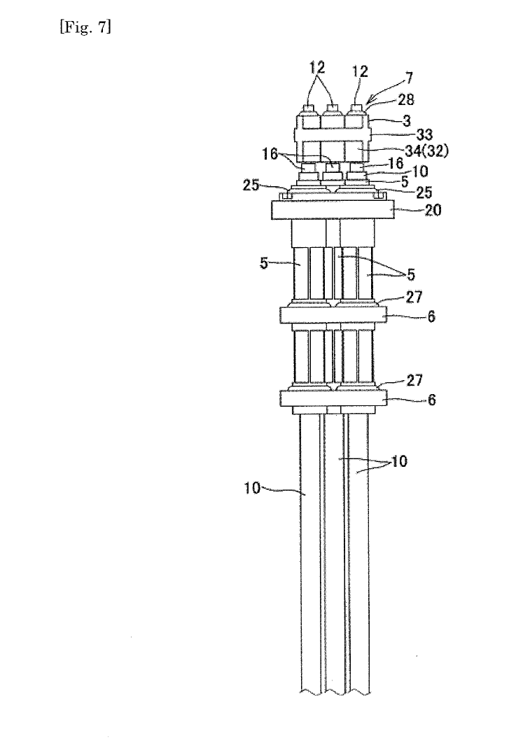

Next, a modification of the inventive wire connection structure for a sheath type heater is described referring to FIG. 6 and FIG. 7.

In this modification, a bell-shaped insulator 16 partly embedded in a sheath 13 is inserted and mounted, as an insulating member, on a protruding root portion of a core wire 11, in place of the insulation ring 14 and the insulator 15. A sleeve pipe 12 is fixedly attached to a tip end of the core wire 11 with respect to an upper end of the bell-shaped insulator 16 by caulking, as well as in the embodiment. This is advantageous in reducing the number of parts, and contributes to cost reduction. Further, the bell-shaped insulator 16 is directly mounted on the core wire 11, without intervening the sleeve pipe 12. This makes it possible to shorten the insulation distance between the core wire 11 and the sheath 13.

In the foregoing representative embodiment, the wire connection plate 3 is formed into a disc plate shape having a large thickness. In this modification, however, a wire connection plate 3 has a reduced thickness. Further, three support cylinders 34 protruding up and down from a disc-shaped main body 33 are provided as seat portions 32 for receiving the core wires 11 and the sleeve pipes 12, and a wire connection portion 7 is formed by inserting and mounting the core wire 11 and the sleeve pipe 12 through a corresponding through-hole 34c formed in the center of each of the support cylinders 34 by welding (see welded portions 28). Accordingly, as compared with the representative embodiment, the contact area between the sleeve pipe 12 and the wire connection plate 3 is increased, electrical connection of the wire connection portion 7 is enhanced, and joint strength is enhanced. Further, only the support cylinders 34 serving as the seat portions 32 are formed to have a long length in the axis direction, whereas the disc-shaped main body 33 is formed into a disc plate shape having a relatively small thickness. This makes it possible to suppress weight increase.

Further, in this modification, an insulation pipe 26 passes through a bottom plate 20, and engages with upper end surfaces of inwardly protruding hexagonal caulk bushings 5, in place of mounting the insulation pipe 26 on the upper surface of the bottom plate 20. This stably holds the insulation pipe 26 at a predetermined position. Accordingly, the above configuration makes it possible to securely maintain insulation properties. The elements other than the above are the same as those in the representative embodiment. Accordingly, the other elements are indicated by the same reference numerals as those in the representative embodiment, and description thereof is omitted herein.

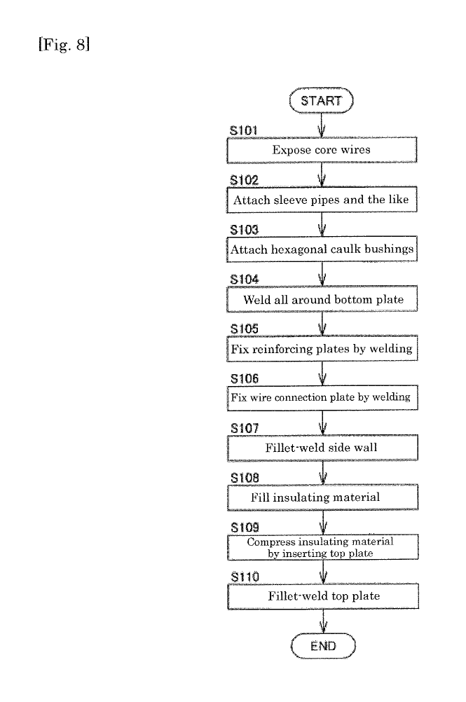

In the following, a sequence of assembling the wire connection structure S in the representative embodiment is described referring to FIG. 8.

At first, the core wires 11 on the distal end side of the three sheath type heating elements 10 are exposed (S101), and the insulation rings 14, the insulators 15, and the sleeve pipes 12 are mounted (S102). Then, a hexagonal caulk bushing 5 is mounted to the outer surface of the heater sheath of each of the sheath type heating elements 10 by a hexagonal caulk (S103). The hexagonal caulk bushings 5 are inserted through the through-hole 20c formed in the bottom plate 20 of the canister 2, followed by welding all around from the inner side of the canister 2 (S104).

Then, the reinforcing plates 6 are mounted through the hexagonal caulk bushings 5 and fixed by welding to thereby interconnect the sheath type heating elements 10 to each other (S105). In this state, the distal ends of the core wires 11, namely, the sleeve pipes 12 are received in the seat portions 32 of the wire connection plate 3, and fixed by welding (S106). By performing the above steps, the wire connection portion 7 is formed. Then, the side wall 21 is fixed to the canister bottom plate 20 by fillet-welding (S107). Then, the insulation pipe 26 is mounted in the side wall 21, and the insulating material 4 is filled in the remaining space of the canister 2 (S108).

Then, the top plate 22 is pressingly inserted into the side wall opening 21a for compressively filling the insulating material 4 (S109). At the time of filling, the insulating material 4 migrates toward the base end side of the wire connection plate 3 through the passage hole 30, and the insulating material 4 fed to the base end side is also compressively filled. Then, the top plate 22 is fixed at the step portion with respect to the upper end surface 21b of the side wall 21 by fillet-welding (S110). The assembling sequence described as above is efficient. However, the inventive wire connection method for a three-phase sheath type heater is not limited to the above.

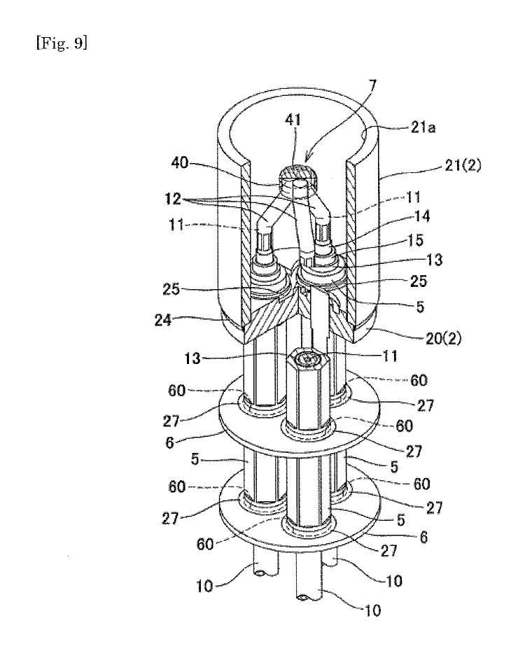

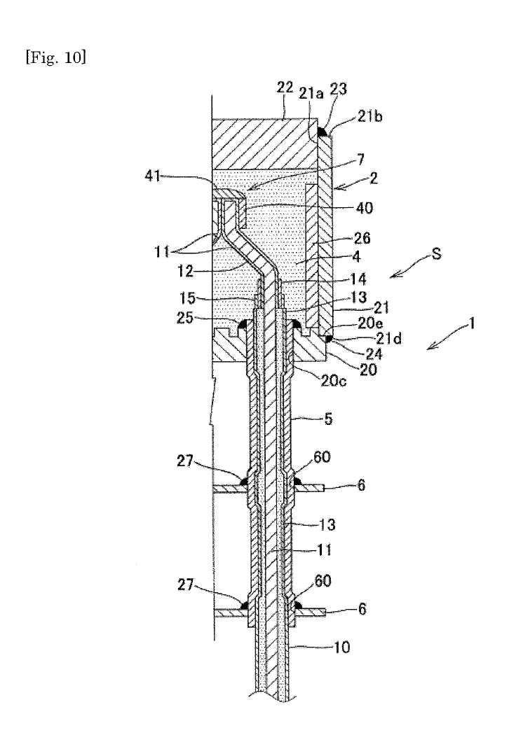

Next, another modification of the wire connection structure is described referring to FIG. 9 and FIG. 10. In this modification, a wire connection portion 7 is formed by directly star-connecting distal ends of core wires 11 to each other by welding in a state that the distal ends of the core wires 11 are bundled together by a bundling member 40 (see a welded portion 41), without using a wire connection plate. In this modification, a sleeve pipe 12 is fixedly attached to the distal end of each of the core wires 11 by caulking, and the core wires 11 with the sleeve pipes 12 are directly star-connected to each other by welding in a state that the core wires 11 are bundled together by the bundling member 40. The bundling member 40 is preferably made of metal, and is fixed on the sleeve pipes 12 by caulking. By the welding, the core wires 11, more specifically, the sleeve pipes 12 are joined to each other, and the bundling member 40 is also integrally joined to the sleeve pipes 12. Use of the bundling member 40 enhances the workability. However, the bundling member 40 may be omitted. The elements other than the above are substantially the same as those in the representative embodiment. Accordingly, the other elements are indicated by the same reference numerals as those in the representative embodiment, and description thereof is omitted herein.

The sequence of assembling the wire connection structure S as described above is basically the same as the representative embodiment, except for the step of forming the wire connection portion 7. Specifically, as in the case of the representative embodiment, reinforcing plates 6 are mounted and fixed to hexagonal caulk bushings 5 by welding, and sheath type heating elements 10 are interconnected to each other. Thereafter, the wire connection portion 7 is formed by bundling the three sleeve pipes 12 by the bundling member 40 by caulking, and by fixing the sleeve pipes 12 to each other by welding. Then, as in the case of the representative embodiment, a side wall 21 is fixed to a canister bottom plate 20 by fillet-welding. The steps thereafter are the same as those in the representative embodiment.

The embodiment of the invention has been described as above. The invention is not limited to the foregoing embodiment, and may be changed or modified in various ways as necessary, as far as such changes and modifications do not depart from the scope of the claims of the invention hereinafter defined.

### REFERENCE SIGNS LIST

1 Three-phase sheath type heater
2 Canister
3 Wire connection plate
4 Insulating material
5 Hexagonal caulk bushing
6 Reinforcing plate
7 Wire connection portion
10 Sheath type heating element
11 Core wire
12 Sleeve pipe
13 Heater sheath
14 Insulation ring
15 Insulator
16 Bell-shaped insulator
20 Bottom plate
20c Through-hole
20e Engaging groove
21 Side wall
21a Opening
21b Upper end surface
21d Lower end surface
22 Top plate
22a Outer circumferential surface
23, 24, and 25 Welded portion
26 Insulation pipe
27 and 28 Welded portion
30 Passage hole
31 Outer circumferential surface
32 Seat portion
33 Disc-shaped main body
34 Support cylinder
34c Through-hole
40 Bundling member
41 Welded portion
60 Through-hole
S Wire connection structure

1. A wire connection structure for a three-phase sheath type heater, wherein:
a canister made of metal is disposed on a distal end side of three sheath type heating elements in a state that a distal end of each of the sheath type heating elements is inserted through a bottom plate,
distal ends of core wires of the sheath type heating elements are star-connected to each other directly or indirectly via another member by welding in the canister, and
an insulating material is filled in the canister.

2. The wire connection structure for a three-phase sheath type heater according to claim 1, wherein
each of the sheath type heating elements is fixed to a peripheral portion of a through-hole in the bottom plate directly or indirectly via another member attached to an outer circumferential portion of a sheath by welding from an inner side of the canister.

3. The wire connection structure for a three-phase sheath type heater according to claim 2, wherein
a hexagonal caulk bushing is attached to the distal end of each of the three sheath type heating elements, and
each of the hexagonal caulk bushings, as the another member, to be inserted into the canister together with the sheath type heating element is fixed to the peripheral portion of the through-hole by welding.

4. The wire connection structure for a three-phase sheath type heater according to claim 3, further comprising:
one or more reinforcing plates, wherein
the reinforcing plate has three through-holes formed therein to allow passing of the hexagonal caulk bushings extending to an outside of the canister, respectively, and
each of the hexagonal caulk bushings passing through the corresponding through-hole is fixed to the peripheral portion of the through-hole by welding from an upper surface side of the reinforcing plate.

5. The wire connection structure for a three-phase sheath type heater according to claim 1, wherein
the canister is constituted of the bottom plate, a tubular side wall which surrounds the distal ends of the three sheath type heating elements passing through the bottom plate, and a top plate which covers an upper end opening of the side wall in a state that the top plate is inserted in the opening, and
the insulating material inside the canister is compressively filled by inserting the top plate into the opening.

6. The wire connection structure for a three-phase sheath type heater according to claim 5, wherein
the top plate is fixed to the side wall by fillet-welding at a step portion with respect to an upper end surface of the side wall.

7. The wire connection structure for a three-phase sheath type heater according to claim 1, further comprising:
an insulating member which is disposed at a root portion of the core wire of each of the sheath type heating elements for preventing discharge accident between the core wire and a sheath.

8. The wire connection structure for a three-phase sheath type heater according to claim 7, wherein
the insulating member is an insulator made of alumina matter.

9. The wire connection structure for a three-phase sheath type heater according to claim 1, wherein
the another member for indirectly star-connecting the distal ends of the core wires of the sheath type heating elements to each other by welding is a wire connection plate made of metal, the wire connection plate being configured such that the distal ends of the core wires of the sheath type heating elements are connected to the wire connection plate by welding for star-connecting the three sheath type heating elements.

10. The wire connection structure for a three-phase sheath type heater according to claim 9, wherein
the wire connection plate has three seat portions equidistantly formed therein for receiving the distal ends of the core wires of the sheath type heating elements, the seat portion being a hole or a groove.

11. The wire connection structure for a three-phase sheath type heater according to claim 10, further comprising:
a sleeve pipe which is fixedly attached to the distal end of each of the core wires by caulking, the sleeve pipe being made of copper or copper alloy, wherein
the sleeve pipe is fixed to the seat portion by welding.

12. The wire connection structure for a three-phase sheath type heater according to claim 9, wherein
the wire connection plate has a passage hole formed in a center portion thereof to allow passing of the insulating material in an axis direction when the insulating material is compressively filled.

13. The wire connection structure for a three-phase sheath type heater according to claim 9, further comprising:
a tubular insulation pipe which is disposed between an outer circumferential surface of the wire connection plate, and an inner circumferential surface of the canister, wherein
the tubular insulation pipe extends to an upper surface of the bottom plate of the canister.

14. The wire connection structure for a three-phase sheath type heater according to claim 1, wherein
the core wires are directly star-connected to each other by welding in a state that the distal ends of the core wires of the sheath type heating elements are bundled together by a bundling member in the canister.

15. The wire connection structure for a three-phase sheath type heater according to claim 14, further comprising:
a sleeve pipe which is fixedly attached to the distal end of each of the core wires by caulking, the sleeve pipe being made of copper or copper alloy, wherein
the core wires with the sleeve pipes are directly star-connected to each other by welding in a state that the core wires are bundled together by the bundling member.

16. A three-phase sheath type heater comprising:
the wire connection structure of claim 1.

17. A wire connection method for a three-phase sheath type heater, comprising:
a step of inserting a distal end of each of three sheath type heating elements through a bottom plate of a canister made of metal;
a step of star-connecting distal ends of core wires of the sheath type heating elements to each other directly or indirectly via another member by welding; and
a step of filling an insulating material into the canister.

18. The wire connection method for a three-phase sheath type heater according to claim 17, further comprising:
a step of fixing each of the sheath type heating elements to a peripheral portion of a through-hole in the bottom plate directly or indirectly via another member attached to an outer circumferential portion of a sheath by welding from an inner side of the canister.

19. The wire connection method for a three-phase sheath type heater according to claim 18, further comprising:
a step of attaching a hexagonal caulk bushing to the distal end of each of the three sheath type heating elements, wherein
each of the hexagonal caulk bushings, as the another member, to be inserted into the canister together with the sheath type heating element is fixed to the peripheral portion of the through-hole by welding.

20. The wire connection method for a three-phase sheath type heater according to claim 19, further comprising:
a step of passing the hexagonal caulk bushings through three through-holes formed in one or more reinforcing plates to allow passing of the hexagonal caulk bushings extending to an outside of the canister, respectively, and of fixing each of the hexagonal caulk bushings to the peripheral portion of the corresponding through-hole by welding from an upper surface side of the reinforcing plate.

21. The wire connection method for a three-phase sheath type heater according to claim 17, wherein
the canister is constituted of the bottom plate, a tubular side wall which surrounds the distal ends of the three sheath type heating elements passing through the bottom plate, and a top plate which covers an upper end opening of the side wall in a state that the top plate is inserted in the opening, and
the method further comprises a step of compressively filling the insulating material inside the canister by inserting the top plate into the opening.

22. The wire connection method for a three-phase sheath type heater according to claim 21, further comprising:
a step of fixing the top plate to the side wall by fillet-welding at a step portion with respect to an upper end surface of the side wall.

23. The wire connection method for a three-phase sheath type heater according to claim 17, further comprising:
a step of disposing an insulating member at a root portion of the core wire of each of the sheath type heating elements for preventing discharge accident between the core wire and a sheath.

24. The wire connection method for a three-phase sheath type heater according to claim 17, wherein
the another member for indirectly star-connecting the distal ends of the core wires of the sheath type heating elements to each other by welding is a wire connection plate made of metal in the canister, and
the distal ends of the core wires of the sheath type heating elements are star-connected to the wire connection plate by welding.

25. The wire connection method for a three-phase sheath type heater according to claim 24, wherein
the wire connection plate has three seat portions equidistantly formed therein for receiving the distal ends of the core wires of the sheath type heating elements, the seat portion being a hole or a groove,
the method further comprises a step of fixedly attaching a sleeve pipe to the distal end of each of the core wires by caulking, the sleeve pipe being made of copper or copper alloy, and
the sleeve pipe is fixed to the seat portion of the wire connection plate by welding.

26. The wire connection method for a three-phase sheath type heater according to claim 24, wherein
the wire connection plate has a passage hole formed in a center portion thereof to allow passing of the insulating material in an axis direction when the insulating material is compressively filled, and
the insulating material fed inside the canister is compressively filled by inserting the top plate into the opening to thereby compressively fill the insulating material fed to a distal end side of the wire connection plate, and at the same time, to migrate the compressed insulating material toward a base end side of the wire connection plate through the passage hole for compressively filling the insulating material fed to the base end side.

27. The wire connection method for a three-phase sheath type heater according to claim 24, further comprising:
a step of disposing a tubular insulation pipe between an outer circumferential surface of the wire connection plate, and an inner circumferential surface of the canister, wherein
the tubular insulation pipe extends to an upper surface of the bottom plate of the canister.

28. The wire connection method for a three-phase sheath type heater according to claim 17, wherein
the core wires are directly star-connected to each other by welding in a state that the distal ends of the core wires of the sheath type heating elements are bundled together by a bundling member in the canister.

29. The wire connection method for a three-phase sheath type heater according to claim 28, further comprising:
a step of fixedly attaching a sleeve pipe to the distal end of each of the core wires by caulking, the sleeve pipe being made of copper or copper alloy, wherein
the core wires with the sleeve pipes are directly star-connected to each other by welding in a state that the core wires are bundled together by the bundling member.
